(19) United States
(12) Patent Application Publication
(10) Pub. No.: US 2014/0085580 A1
(43) Pub. Date: Mar. 27, 2014

(54) METHOD FOR FORMING FILM

(71) Applicant: Kabushiki Kaisha Toshiba, Minato-ku (JP)

(72) Inventors: Yasuhiko Fuchikami, Kanagawa-ken (JP); Tsuyoshi Sato, Kanagawa-ken (JP)

(73) Assignee: KABUSHIKI KAISHA TOSHIBA, Minato-ku (JP)

(21) Appl. No.: 14/017,460

(22) Filed: Sep. 4, 2013

(30) Foreign Application Priority Data
Sep. 21, 2012 (JP) 2012-208920

(51) Int. Cl. G02F 1/1337

(52) U.S. Cl. CPC G02F 1/1337
USPC 349/123; 427/284; 427/58

(57) ABSTRACT

According to an embodiment, a method for forming a film, the film including a first portion provided on a substrate and a second portion provided along an outer edge of the first portion, and surrounding the first portion, includes a step of forming the second portion by spraying liquid drops on the substrate, each of the liquid drops containing material of the second portion. The method also includes a step of forming the first portion by spraying other liquid drops on a region in the substrate, the region being surrounded by the second portion, and each of the other liquid drops containing material of the first portion.

### CROSS-REFERENCE TO RELATED APPLICATIONS

This application is based upon and claims the benefit of priority from Japanese Patent Application No. 2012-208920, filed on Sep. 21, 2012; the entire contents of which are incorporated herein by reference.

### FIELD

Embodiments are generally related to a method for forming film.

### BACKGROUND

A liquid crystal display device includes an alignment film, which is formed using, for example, an ink jet system. It may be possible in the ink jet system to form the alignment film having uniform thickness by reducing viscosity of ink or by reducing surface tension of ink. It may also be possible in the ink jet system to form the uniform film by reducing a contact angle of ink on a substrate. However, these methods make the ink spreading wider on the substrate and make the alignment film having a rough edge. Hence, the ink jet system is difficult to apply to small-sized devices, in which a peripheral area is desired to be smaller.

### BRIEF DESCRIPTION OF THE DRAWINGS

FIGS. 1A to 1C are schematic views illustrating an example of a substrate unit for a liquid crystal display device according to a first embodiment;

FIG. 2 is a partial cross-sectional view illustrating an example of a liquid crystal display device according to the first embodiment;

FIG. 3 is a flow chart illustrating an example process for manufacturing the liquid crystal display device according to the first embodiment;

FIG. 4 is a flow chart illustrating an example process for forming an alignment film according to the first embodiment;

FIGS. 5A and 5B are perspective views illustrating an example method for manufacturing the liquid crystal display device according to the first embodiment;

FIGS. 6A to 6F are schematic views and a graph illustrating the example method for manufacturing the liquid crystal display device according to the first embodiment;

FIG. 7 is a graph illustrating an example requirement for manufacturing the liquid crystal display device according to the first embodiment;

FIG. 8 is a graph illustrating another example requirement for manufacturing the liquid crystal display device according to the first embodiment;

FIGS. 9A and 9B are a graph and a schematic view respectively, illustrating other example requirement for manufacturing the liquid crystal display device according to the first embodiment;

FIG. 10 is a schematic perspective view illustrating an example method for manufacturing the liquid crystal display device according to a comparable example of the first embodiment;

FIG. 11 is a schematic plan view illustrating an example of a substrate unit for a liquid crystal display device according to a second embodiment;

FIGS. 12A to 13C are plan views and graphs illustrating examples of a peripheral frame of an alignment film for the liquid crystal display device according to the second embodiment;

FIGS. 14A to 14D are schematic views illustrating an example of a substrate unit for a liquid crystal display device according to a third embodiment;

FIGS. 15A to 15C are schematic cross-sectional views illustrating an example of a substrate unit for a liquid crystal display device according to a fourth embodiment; and

FIGS. 16A and 16B are schematic cross-sectional views illustrating an example of a substrate unit for a liquid crystal display device according to a comparable example.

### DETAILED DESCRIPTION

According to an embodiment, a method for forming a film, the film including a first portion provided on a substrate and a second portion provided along an outer edge of the first portion, and surrounding the first portion, includes a step of forming the second portion by spraying liquid drops on the substrate, each of the liquid drops containing material of the second portion. The method also includes a step of forming the first portion by spraying other liquid drops on a region in the substrate, the region being surrounded by the second portion, and each of the other liquid drops containing material of the first portion.

According to other embodiment, a liquid crystal display device includes a substrate and an alignment film provided on the substrate. The alignment film includes a first portion provided in a region corresponding to a display portion and a second portion provided along an outer edge of the first portion and surrounding the first portion, the second portion being provided to be higher than the first portion.

Herein below, embodiments are described with reference to the drawings.

### First Embodiment

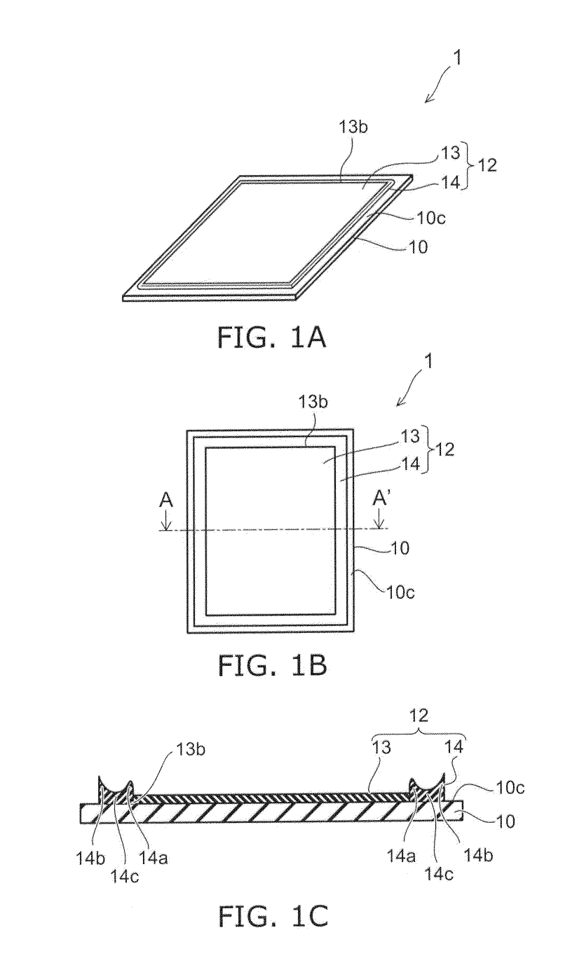

FIG. 1A is a perspective view illustrating a substrate unit of a liquid crystal display device according to a first embodiment. FIG. 1B is a plan view of the substrate unit 1, and FIG. 1C is a cross-sectional view taken along line AA′ shown in FIG. 1B.

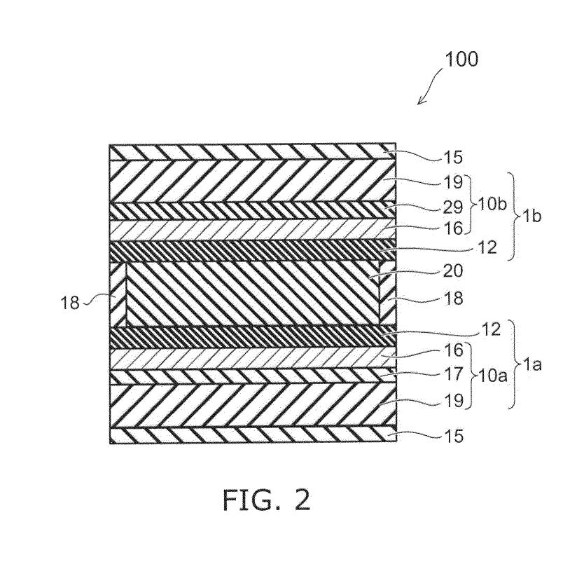

FIG. 2 is a partial cross-sectional view illustrating a liquid crystal display device 100 according to the first embodiment.

As shown in FIG. 2, the liquid crystal display device 100 includes a first substrate unit 1a, a second substrate unit 1b, and a liquid crystal layer 20 provided therebetween.

The first substrate unit 1a includes an array substrate 10a and an alignment film 12. The array substrate 10a includes, for example, a glass substrate 19, a protection layer 17, and a transparent electrode 16. A drive circuit (not shown) is provided between the glass substrate 19 and the protection layer 17. The drive circuit includes, for example, a TFT transistor etc., and the circuit drives the liquid crystal layer 20 via the transparent electrode 16.

The second substrate unit 1b includes a color filter (CF) substrate 10b and an alignment film 12. The CF substrate 10b includes, for example, a glass substrate 19, a color filter layer 29, and a transparent electrode 16.

The second substrate unit 1b is disposed to face the first substrate unit 1a via a spacer 18, and the liquid crystal layer 20 is provided between alignment films 12 of the first substrate unit 1a and the second substrate unit 1b. A polarizing filter 15 is attached to each of back surfaces of the first substrate unit 1a and the second substrate unit 1b (a surface on a side opposite to a surface on which the alignment film 12 is provided).

The substrate unit 1 illustrated in FIG. 1A to FIG. 1C shows a common structure between the first substrate unit 1a and the second substrate unit 1b. That is, the substrate unit 1 includes a substrate 10 and the alignment film 12 provided on the upper surface 10c of the substrate 10.

As shown in FIG. 1A and FIG. 1B, the alignment film 12 includes a first portion 13 provided in a region corresponding to the liquid crystal display portion and a second portion 14 provided around the first portion. The alignment film 12 is, for example, a polyimide film.

The projected shape of the first portion 13 on the upper surface 10c of the substrate 10 is rectangular, and the two sets of parallel sides of the rectangle have lengths of, for example, 75 mm and 53 mm. The thickness of the first portion 13 is 83 nm to 140 nm, for example 100 nm.

The second portion 14 is provided along the outer edge 13b of the first portion 13, and is adjoined to the first portion 13. The width of the second portion, i.e. the spacing between the outer edge 13b of the first portion and the outer edge of the second portion is, for example, 54 μm to 3 mm.

As shown in FIG. 1C, the second portion 14 has a protrusion 14a provided along the outer edge 13b of the first portion 13 and a protrusion 14b provided along the outer edge of the protrusion 14a. The protrusions 14a and 14b are provided to be higher than the first portion, and the heights of the protrusions 14a and 14b from the substrate may be in a range of 170 to 200 nm, for example. In contrast, the height of a recess 14c between the protrusion 14a and the protrusion 14b is 15 to 40 nm, for example. As described later, the heights of the protrusions 14a and 14b may be increased to 1.5 μm to 4 μm by repeatedly applying polyimide (PI) to the second portion 14.

Thereby, the material of the alignment film 12, which is applied to the first portion 13, may be prevented from spreading outward over the second portion 14. Consequently, the peripheral portion of the substrate unit 1 between the outer edge of the alignment film 12 and the outer edge thereof may be designed to be narrower, and it becomes possible to downsize the liquid crystal display device 100.

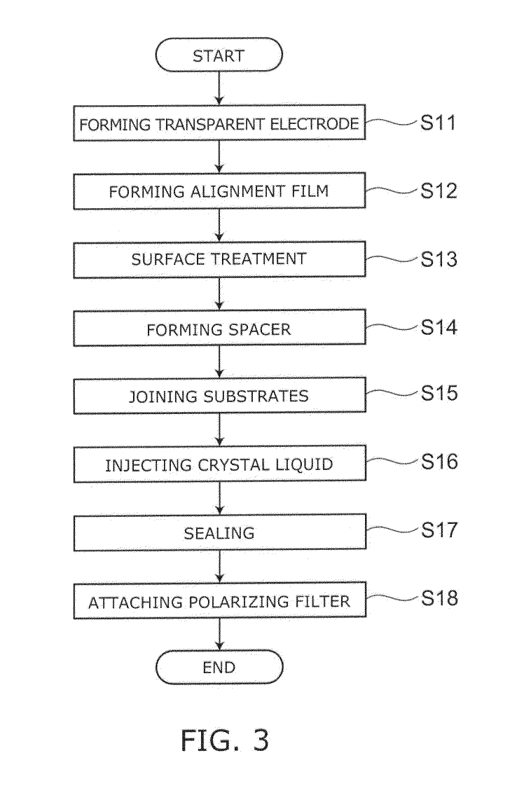

Next, a method for manufacturing the liquid crystal display device 100 is described with reference to FIG. 3 to FIG. 5B.

FIG. 3 is a flow chart illustrating the manufacturing process of the liquid crystal display device according to the first embodiment.

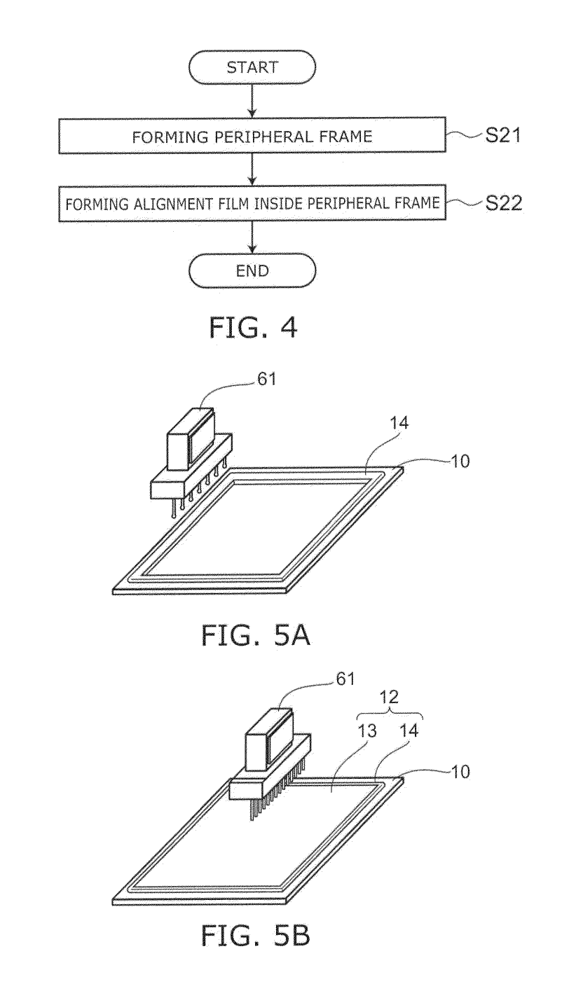

FIG. 4 is a flow chart illustrating a process of forming an alignment film according to the first embodiment.

FIGS. 5A and 5B are perspective views illustrating a method for manufacturing the liquid crystal display device according to the first embodiment.

As shown in step S11, the transparent electrode 16 is formed on the array substrate 10a and the CF substrate 10b. Subsequently, the substrates 10a and 10b are cleaned in pure water using ultrasonic power for two minutes, and exposed to ultraviolet irradiation for 60 seconds. Thereby, a contact angle of an organic solvent containing the material of the alignment film 12 becomes smaller on the transparent electrode 16, for example, 3 degrees or less.

Next, as shown in step S12, the alignment film 12 is formed individually on the array substrate 10a and on the CF substrate 10b.

As shown in FIG. 4, the alignment film 12 is provided in two separate steps. The second portion 14 is provided in step S21, where a peripheral frame is formed on the substrates. Subsequently, the first portion 13 is formed on a region inside the peripheral frame.

As shown in FIGS. 5A and 5B, the alignment film 12 is formed using the ink jet (IJ) method, for example. In the ink jet method, liquid drops (i.e. ink) are sprayed from an IJ head 61 toward the substrate 10. Each of the liquid drops contains polyimide (PI) that is the material of the alignment film 12. That is, the ink used here is an organic solvent in which polyimide is dispersed, and contains, for example, 3% polyimide (PI), 67% N-methyl-2-pyrrolidone (NMP), and 30% butyl-cellosolve (BC) by weight.

As shown in FIG. 5A, in step S21, the IJ head 61 is moved along a region where the second portion 14 will be formed, and ink containing the material of the second portion is applied thereon. At this time, the temperature of the array substrate 10a and the CF substrate 10b is kept at 60° C., for example.

Subsequently, the applied ink is cured under conditions of, for example, 230° C. and 14 minutes to form a peripheral frame (the second portion 14).

Next, as shown in FIG. 5B, ink containing the material of the first portion 13 is applied to the region inside the peripheral frame (step S22).

The ink used for forming the first portion 13 may be the same one as the ink used for the peripheral frame (the second portion 14), and contains, for example, 3% polyimide (PI), 67% N-methyl-2-pyrrolidone (NMP), and 30% butyl cellosolve (BC) by weight.

In order to maintain the viscosity of the ink, while applying the ink to the region inside the peripheral frame, the array substrate 10a and the CF substrate 10b are kept lower temperature. For example, the ink applied to the first portion 13 may be sprayed at room temperature. As described above, a surface of the transparent electrode 16, on which the ink is applied, is treated before spraying the ink, so that the contact angle of the ink becomes 3 degrees or less thereon. Therefore, the ink sprayed from the IJ head 61 may spread easily on the application surface. Thereby, the ink spreads uniformly inside the peripheral frame, and the first portion 13 provided after the cure treatment has uniform thickness.

Next, as shown in step S13 of FIG. 3, the surface treatment, such as the surface cleaning is performed for the alignment film 12. Subsequently, as shown in step S14, the spacer 18 is formed on at least one of the array substrate 10a and the CF substrate 10b. The spacer 18 is formed on a face on which the alignment film 12 is provided.

Next, as shown in step S15, the array substrate 10a is disposed above the CF substrate 10b so that the faces thereof, on which the alignment films 12 are provided respectively, are opposed to each other. It is also possible to dispose the CF substrate above the array substrate 10a. Subsequently, the array substrate 10a and the CF substrate 10b are joined together via the spacer 18.

Next, as shown in step S16, a liquid crystal is injected between the surface of the array substrate 10a on which the alignment film 12 is formed and the surface of the CF substrate 10b on which the alignment film 12 is formed. Subsequently, as shown in step S17, the liquid crystal is sealed to form the liquid crystal layer 20.

Next, as shown in step S18, the polarizing filter 15 is attached individually to the back surface of the array substrate 10a on a side opposite to the surface on which the alignment film 12 is formed, and to the back surface of the CF substrate 10b on a side opposite to the surface on which the alignment film 12 is formed. Thereby, the liquid crystal display device 100 shown in FIG. 2 is completed.

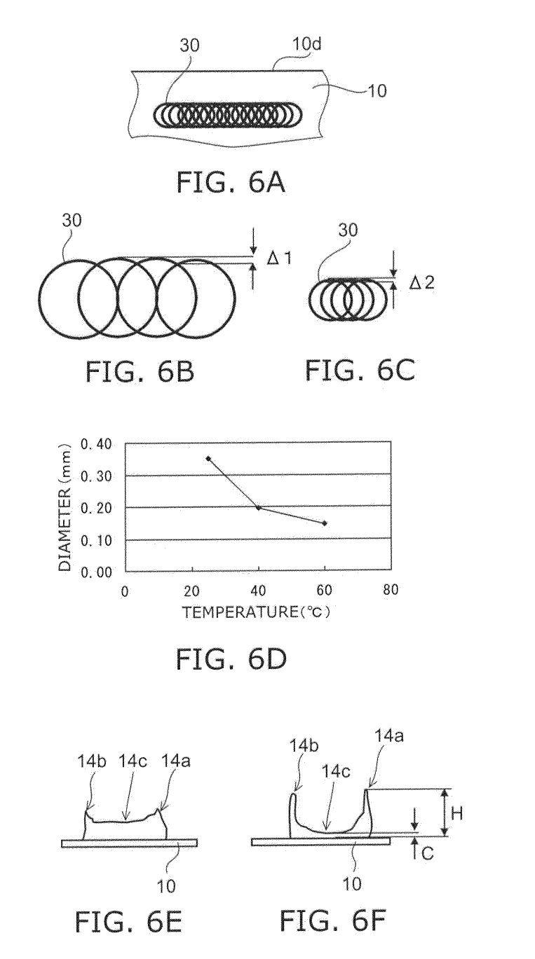

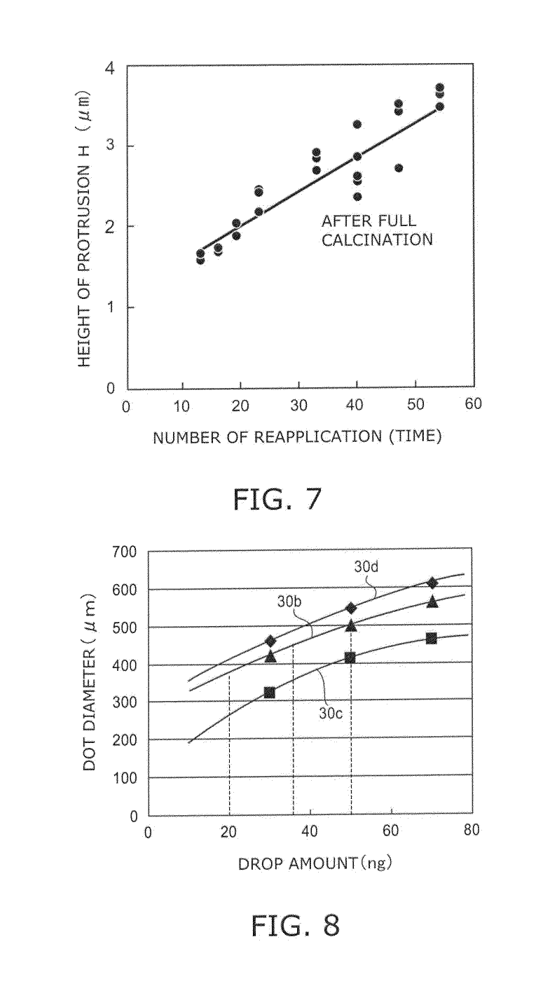

Next, the requirements for forming the second portion 14 (hereinafter, the “peripheral frame”) of the alignment film 12 are described with reference to FIGS. 6A to 6F and FIG. 7.

FIG. 6A to FIG. 6C are plan views schematically illustrating a method for forming the peripheral frame.

FIG. 6D is a graph illustrating the relationship between the substrate temperature while forming the peripheral frame, and the diameter of the ink dot formed on the substrate. The vertical axis represents the diameter, and the horizontal axis represents the substrate temperature.

FIG. 6E and FIG. 6F are schematic cross-sectional views of the peripheral frame.

A liquid drop sprayed from the IJ head 61 forms an ink dot 30 containing the material of the alignment film 12 on the substrate 10, for example. By spraying liquid drops while moving the IJ head 61, the peripheral frame is formed on the substrate, in which ink dots 30 are arranged in a prescribed direction.

As shown in FIG. 6A, the ink dots 30 provided on the substrate are arranged on a straight line. The ink dots 30 are adjoined to each other with a pitch narrower than the diameter of each dot 30, overlapping with each other. The fixed distance is kept between the center of each ink dot 30 and the outer edge 10d of the substrate 10. Thereby, the peripheral frame that extends in a straight line, and it may be possible to suppress the degree of disorder in the outer edge thereof. FIG. 6B and FIG. 6C are schematic plan views illustrating the ink dots 30 formed on the substrates having different in temperature from each other. FIG. 6C shows an example in which the ink is applied on the substrate kept at a higher temperature than in an example shown in FIG. 6B. Comparing each one to the other, it is found that the diameter of the ink dot 30 becomes smaller by keeping the substrate 10 at higher temperature.

That is, as shown in FIG. 6D, the diameter of the ink dot 30 decreases as the substrate temperature is increased. For example, the diameter of the ink dot 30 is 0.35 mm at room temperature (25° C.), and it decreases to 0.14 mm when the substrate temperature is increased to 60° C.

Also the degree of disorder Δ in the outer edge of the peripheral frame formed by joining the ink dots 30 can be suppressed to be smaller (Δ1>Δ2) by keeping the substrate 10 at higher temperature. For example, when the ratio between the pitch and the diameter of the ink dot 30 is constant, the degree of disorder may be suppressed by employing a higher temperature condition that provides a small diameter. Furthermore, a substrate heated at a higher temperature makes the organic solvent vaporize more rapidly, and then makes the fluidity of ink smaller. Thereby, the ink spreading is suppressed in the lateral direction along the substrate surface. By narrowing the pitch of disposing ink dots 30, the ink applied on the substrate becomes thicker. That is, it becomes possible to increase the ratio of the diameter to the pitch, and the degree of disorder Δ can be reduced in the outer edge of the peripheral frame.

FIG. 6E and FIG. 6F schematically show cross-sections of the peripheral frame, corresponding to the cross section of the second portion 14 of FIG. 1C. In an example shown in FIG. 6F, the substrate temperature while spraying ink is higher than in an example shown in FIG. 6E. As shown in both drawings, the protrusions 14a and 14b are formed at the edge portions on both sides of the peripheral frame, protruding above the central portion and forming a recess 14c therebetween. This is a phenomenon so called a coffee ring, and is caused depending drying speed of ink, when the drying speed at both ends is slower than that in the central portion.

As shown in FIG. 6F, when the temperature of the substrate 10 is higher, the heights H of the protrusions 14a and 14b are larger than that of the recess 14c. That is, the thickness of both edge portions is thicker than the thickness C of the recess 14c in a cross section orthogonal to the extending direction of the peripheral frame.

As shown in FIG. 6E, when the temperature of the substrate 10 is lower, the difference is smaller between the drying speed at edge portion and the drying speed in the central portion. Consequently, the difference becomes smaller between the height H of the protrusions 14a or 14b and the thickness C of the recess 14c. The heights of the protrusions 14a and 14b shown in FIG. 6E are lower than those shown in FIG. 6F. That is, setting the substrate temperature higher, while forming the peripheral frame, makes the larger difference between the height H of the protrusions 14a or 14b and the thickness C of the recess 14c, and makes the protrusions 14a and 14b higher. Thereby, the ink applied inside the peripheral frame can be prevented from spreading beyond the peripheral frame.

As shown in Table 1, when the substrate temperature is 25° C., the height H of the protrusions 14a and 14b is 40 to 48 nm, and the thickness C of the recess 14c is 4 to 9 nm. On the other hand, when the substrate temperature is set to 60° C., the height H of the protrusions 14a and 14b is 177 to 200 nm. The thickness of the recess 14c is 15 to 36 nm.

TABLE 1

| Substrate | Protrusion | Recess |
|---|---|---|
| temperature | height H(nm) | thickness C(nm) |
| 25° C. | 40~48 | 4~9 |
| 40° C. | 48~50 | 10~23 |
| 60° C. | 117~200 | 15~36 |

Furthermore, the protrusions 14a and 14b can be made higher by repeatedly applying ink to the region in the peripheral frame where the ink has already applied.

FIG. 7 is a graph illustrating the relationship between the height H of the protrusion and the number of times of applying ink. The vertical axis represents the height H of the protrusion, and the horizontal axis represents the number of times of applying ink. The height H of the protrusion increases as the number of times of spraying liquid drops on the ink dots 30 formed on the substrate 10 increases. For example, repeatedly applying ink 20 times or more may make the protrusion height 2 μm or more. The protrusion height becomes 2.5 μm or more, when applying ink 30 times or more.

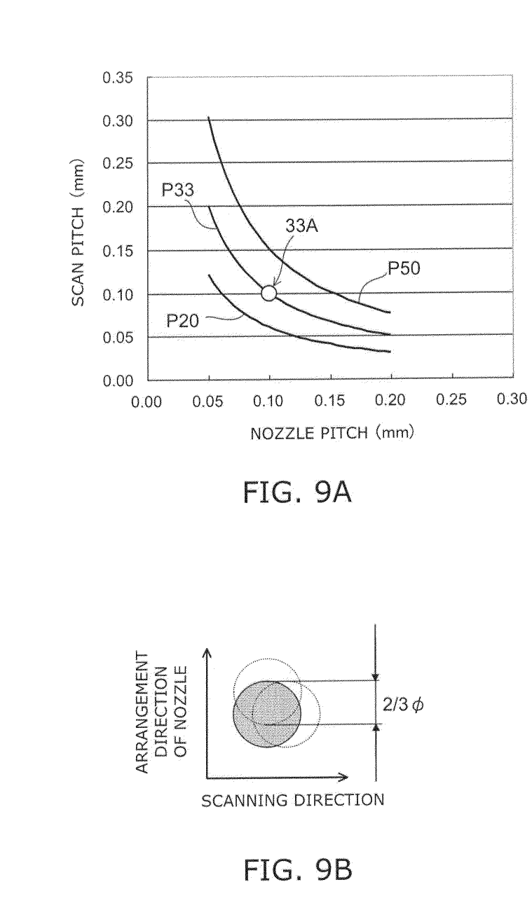

Next, the requirements for forming the first portion 13 of the alignment film 12 are described with reference to FIG. 8 and FIGS. 9A and 9B.

FIG. 8 is a graph illustrating relationships between amount of a liquid drop sprayed from the IJ head 61 and the diameter of the ink dot. The vertical axis represents the diameter, and the horizontal axis represents the amount of a liquid drop by weight (ng). Graph 30b in the drawing shows the diameter of the ink dot on the array substrate 10a, and Graph 30c shows the diameter of the ink dot on the CF substrate 10b. Graph 30d shows the diameter of the ink dot on a glass substrate, for comparison.

Graph 30b and Graph 30c are located below Graph 30d, and the diameter of the ink dot 30 is smaller on the array substrate 10a and the CF substrate 10b than that on the glass substrate.

The diameter of the ink dot 30 on the array substrate 10a shown in Graph 30b is 400 to 500 μm when the drop amount is in a range of 20 to 50 ng. On the array substrate 10a, the shape of the ink dot may be elliptical due to the influence of the circuit pattern. In such a case, the major axis of the ellipse is taken as the diameter of the ink dot.

On the CF substrate 10b, the diameter of the ink dot 30 is 250 to 400 μm when the drop amount is in a range of 20 to 50 ng, as shown in Graph 30c.

For example, a drop amount of 20 to 50 ng may be employed for making the diameter of the ink dot 30 in a range of 250 to 500 μm on the array substrate 10a and the CF substrate 10b. The drop amount may be set to 37 ng for making the diameter of the ink dot 30 in a range of 350 to 450 μm on the array substrate 10a and the CF substrate 10b.

FIG. 9A is a graph illustrating a pitch of spraying liquid drops for making the alignment film 12 with a film thickness of 100 nm.

As shown in FIG. 5, the IJ head 61 includes a plurality of jet nozzles disposed in a straight line. When forming the first portion 13, the IJ head 61 sprays ink toward the substrate while moving (scanning) in a direction orthogonal to the arrangement direction of the jet nozzles.

The vertical axis of FIG. 9A represents the scanning pitch corresponding to the time interval with which liquid drops are sprayed from the IJ head 61, and the horizontal axis represents the arrangement pitch of jet nozzles in the IJ head 61. P20, P33, and P50 in the drawing indicate the relationship between the pitch of jet nozzles and the scanning pitch when setting the drop amount to 20 ng, 33 ng, and 50 ng, respectively.

To control the film thickness of the alignment film 12 to be a prescribed value, the scan pitch becomes narrower, when setting the nozzle pitch wider, as shown in FIG. 9A. On the other hand, the scan pitch is made wider, when setting the nozzle pitch narrower. When the drop amount is larger, both the nozzle pitch and the scan pitch are made wider. When the drop amount is smaller, both the nozzle pitch and the scan pitch are made narrower.

Point 33A shown in FIG. 9A indicates one requirement, where the drop amount is set to 33 ng. For example, when the drop amount is set to 33 ng, the diameter of the ink dot 30 on the CF substrate 10b is approximately 330 μm (see FIG. 8). According to the relationship shown in FIG. 9A, both the nozzle pitch and the scan pitch are set to 0.1 mm to form the alignment film 12 with a thickness of 100 nm.

Under this requirement, as shown in FIG. 9B, the ink is applied so that two thirds of an ink dot 30 overlaps with two thirds of adjoined ink dot 30 both in the arrangement direction of the nozzles and in the scanning direction. Then, the first portion 13 of the alignment film formed inside the peripheral frame has a thickness of 130 nm to 140 nm after temporary curing (60° C., 2 minutes), and has a thickness of 83 nm to 93 nm after complete curing (230° C., 14 minutes). These values are smaller than the height of the protrusions 14a and 14b in the peripheral frame formed at a substrate temperature of 60° C. (177 to 200 nm), for example. That is, the peripheral frame may suppress the spreading of ink applied to the region inside the peripheral frame.

The requirement mentioned above is one example, and the nozzle pitch of the IJ head 61 and the scanning pitch can be set arbitrarily in accordance with the graph shown in FIG. 9A. The spreading of the alignment film 12 may be suppressed by making the height of the protrusions 14a and 14b in the peripheral frame higher than the thickness of the alignment film formed inside the peripheral frame. That is, by setting the substrate temperature to 60° C. or more, a desired peripheral frame can be formed using the ink jet method. When the height of the protrusions 14a and 14b in the peripheral frame is insufficient with respect to the film thickness of the alignment film 12 (i.e. the first portion 13), the protrusions 14a and 14b may be formed higher by repeatedly applying ink to the peripheral frame 12.

Thus, the alignment film 12 includes the first portion 13 and the second portion 14 (the peripheral frame) surrounding the periphery of the first portion 13. The spacing between the outer edge of the second portion 14 and the outer edge of the substrate 10 can be controlled with high accuracy. It is also possible to suppress the degree of disorder in the outer edge of the second portion 14. Thereby, the spacing between the outer edge of the alignment film 12 and the outer edge of the substrate 10 may be set narrower, and the downsizing of the liquid crystal display device can be achieved using the ink-jet system.

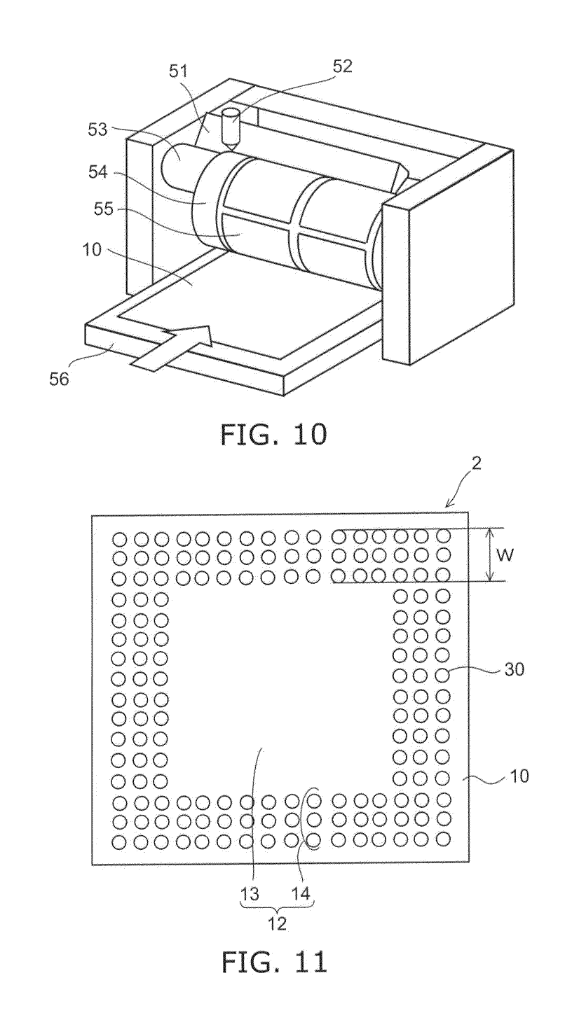

Also a flexographic transfer apparatus 50 shown in FIG. 10, for example, may be used for forming the alignment film 12. The flexographic transfer apparatus 50 includes a doctor blade 51, a dispenser 52, an anilox roll 53, a printing roll 54, a flexographic plate 55, and a stage 56. Ink containing the material of the alignment film is supplied from the dispenser 52 to the doctor blade 51. The ink is made to have uniform thickness between the doctor blade 51 and the anilox roll 53, and is supplied to the flexographic plate 55 attached to the surface of the printing roll 54. Then, the flexographic plate 55 is pressed against the substrate 10 to transfer the alignment film formed on the flexographic plate 55.

In the flexographic transfer apparatus 50, the flexographic plate 55 is prepared so as to use only for each of different kinds of liquid crystal display devices. Therefore, the costs for preparing the flexographic plate are added to the manufacturing costs. In addition, the flexographic plate 55, the anilox roll 53, the printing roll 54, and the doctor blade 51 are cleaned and replaced periodically. The parts replacement may reduce the productivity. The cleaning and replacing processes may generate dusts, and the dust adhesion to the film may generate a defect in the device.

In contrast, in the embodiment using the ink jet method, the application conditions may be altered and the ink may be changed for each of the different kinds of liquid crystal display devices. Therefore, the manufacturing conditions are easily changed depending on the type of the liquid crystal display device, and then it becomes possible to reduce running cost. Furthermore, small frequency of the part replacement suppresses the dusts, and then may reduce the manufacturing failure rate.

### Second Embodiment

FIG. 11 is a plan view schematically illustrating a substrate unit 2 of a liquid crystal display device according to a second embodiment. The substrate unit 2 according to the embodiment includes the substrate 10 and the alignment film 12 provided on the substrate 10. The alignment film 12 includes the first portion 13 corresponding to the display portion and the second portion 14 (i.e. the peripheral frame) surrounding the first portion 13.

The second portion 14 includes a plurality of dots 40. The dots 40 are provided apart from each other, for example. The width of the second portion 14, that is, the spacing W between the outer edge of the first portion 13 and the outer edge of the second portion 14 is, for example, 3 mm. Alternatively, the dots 40 may be provided in contact with each other.

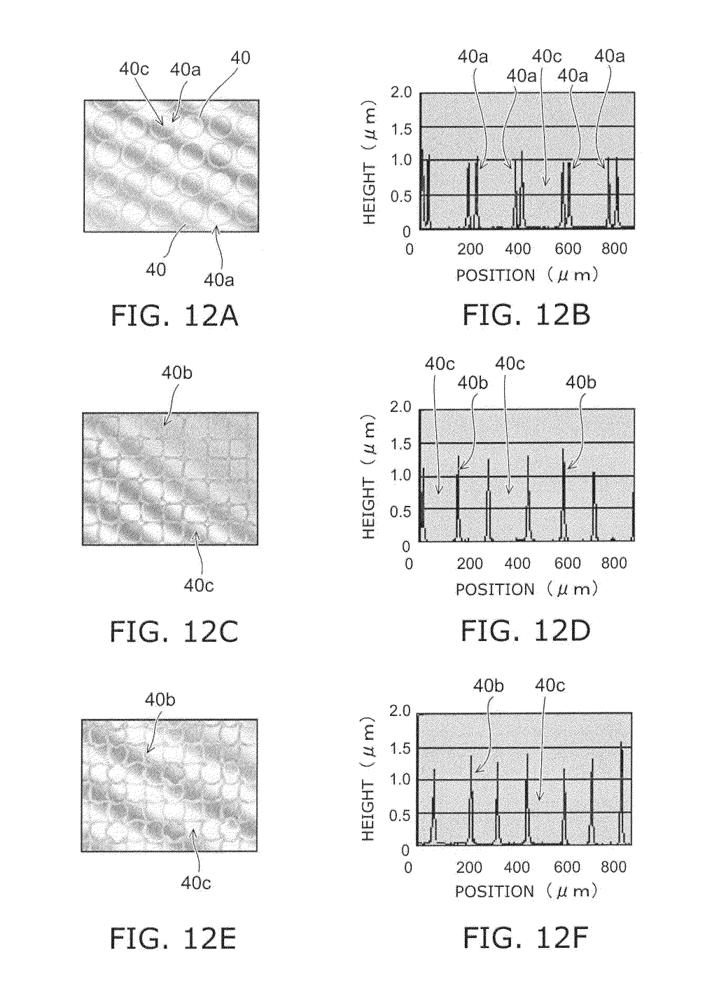

FIGS. 12A to 12F are plan views and graphs illustrating the peripheral frame of the liquid crystal display device according to the second embodiment. For example, the amount of a liquid drop sprayed to the substrate 10 is set to 37 ng and the substrate temperature is set to 60° C. FIG. 12A, FIG. 12C, and FIG. 12E are example images, in which the pitch of dots 40 is set to 200 μm, 150 μm, and 133 μm, respectively. FIG. 12B, FIG. 12D, and FIG. 12F are graphs showing the heights of the protrusions 40a and 40b in the dot 40. The vertical axis represents the height of the protrusion, and the horizontal axis represents the position on the substrate 10.

In the case where the drop amount is set to 37 ng and the substrate temperature is set to 60° C., the diameter of the dot 40 is approximately 140 μm. Therefore, when the arrangement pitch is set to 200 μm, dots 40 are provided apart from each other as shown in FIG. 12A. The height of the protrusion 40a provided at the edge of the dot 40 is approximately 1 μm as shown in FIG. 12B. The recess 40c provided between protrusions 40a is very thin.

In the example shown in FIG. 12C, the diameter and the pitch of dots 40 are almost equal, and a plurality of dots 40 are in contact with each other. In this case, the height of the protrusion 40b shown in FIG. 12D is 1.3 μm, which is slightly higher than in the case of being provided apart from each other.

In the example shown in FIG. 12E, the overlap between dots 40 is larger, and the diameter of the recess 40c in a mesh form is slightly smaller than in the case shown in FIG. 12C. As shown in FIG. 12F, the height of the protrusion 40b is approximately 1.5 μm.

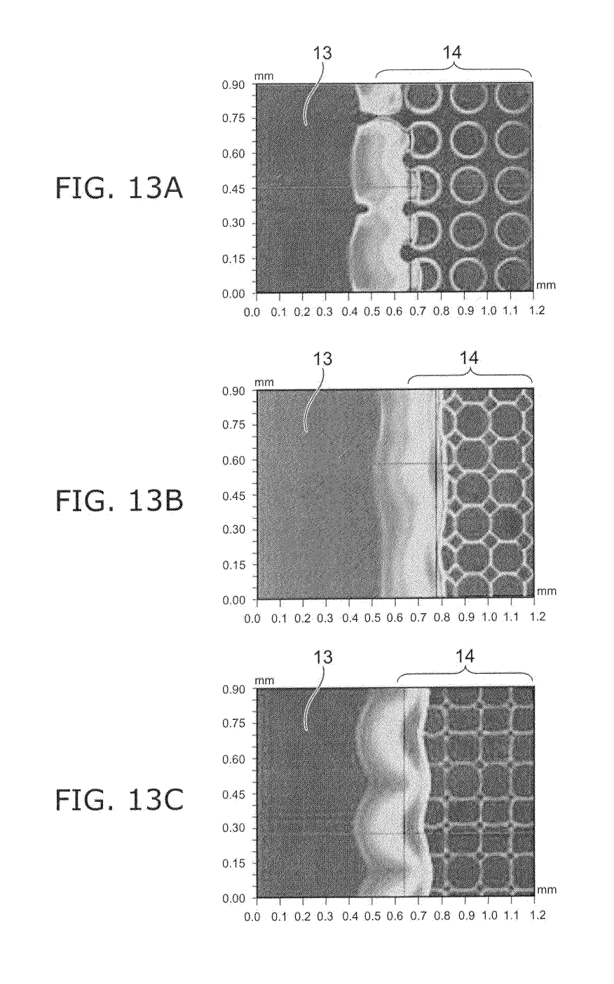

FIG. 13A to FIG. 13C are other plan views illustrating the peripheral frames of the liquid crystal display device according to the second embodiment, and show the boundaries between the first portion 13 and the second portion 14 (the peripheral frame). In FIG. 13A, the pitch of dots 40 is 200 μm, and the dots 40 are apart from each other. In FIG. 13B and FIG. 13C, the arrangement pitches of dots 40 are 150 μm and 133 μm, respectively.

In FIG. 13A, the ink applied to the first portion 13 spreads over the dots 40 in the first row, and is blocked by the dots 40 in the second row. On the other hand, in FIG. 13B and FIG. 13, the ink spreading is blocked by the dots 40 in the first row. Comparing FIG. 13B and FIG. 13C, the ink spreading is slightly larger in the example shown in FIG. 13B. That is, the ink spreading is related to the height of the protrusion 40b.

Also in the manufacturing process according to the embodiment, ink containing the material of the alignment film is applied to the region surrounded by the peripheral frame (the second portion 14) after forming the peripheral frame. When the ink spreads along the surface of the substrate 10 and comes into contact with the peripheral frame, the material of the alignment film contained in the peripheral frame may dissolves, for example. Thereby, the concentration of the material of the alignment film increases in the ink, and then the ink spreading is suppressed due to the increased viscosity. Consequently, it may be possible to suppress the ink spreading beyond the peripheral frame.

Thus, the second portion 14 (the peripheral frame) may be provided including the dots 40. The dots 40 may be disposed to be apart from one another, or may be in contact with each other. Thereby, the spreading of the ink applied to the first portion 13 may be suppressed, and it becomes possible to downsize the liquid crystal display device using ink-jet method.

### Third Embodiment

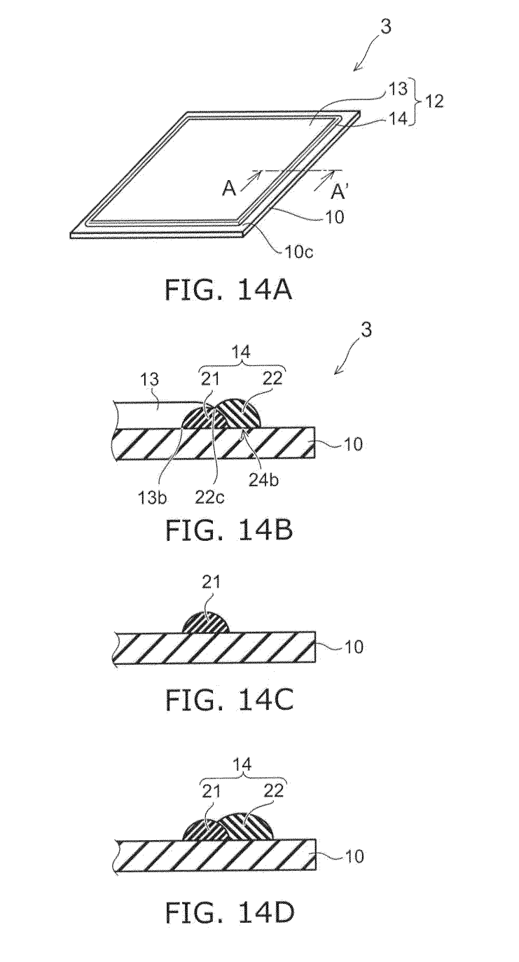

FIG. 14A to FIG. 14D are schematic views illustrating a substrate unit 3 of a liquid crystal display device according to a third embodiment. FIG. 14A is a perspective view showing the substrate unit 3, and FIG. 14B to FIG. 14D are cross-sectional views taken along line AA′ shown in FIG. 14A.

As shown in FIG. 14A, the substrate unit 3 in the embodiment includes the substrate 10 and the alignment film 12 provided on the upper surface 10c of the substrate 10. The alignment film 12 includes the first portion 13 corresponding to the display portion and the second portion 14 surrounding the periphery of the first portion 13.

As shown in FIG. 14B, the second portion 14 further includes a first frame 21 and a second frame 22. The first frame 21 is provided along the outer edge 13b of the first portion 13. The first frame 21 contains a material that reduces the contact angle of the ink applied to the first portion 13. The contact angle of the ink on the first frame 21 is, for example, 5 degrees or less.

The second frame 22 is provided along the outer edge 24b of the first frame 21. The second frame 22 contains a material that increases the contact angle of the ink applied to the first portion 13. The contact angle of the ink on the second frame 22 is, for example, 40 degrees or more.

The second frame 22 includes a portion in contact with the upper surface 10c of the substrate 10 and a portion in contact with the first frame 21. The inner edge 22c of the second frame 22 is provided near the top of the first frame 21, and is in contact with the first frame 21. The first portion 13 includes a portion in contact with the upper surface 10c of the substrate 10 and a portion in contact with the first frame 21. The first portion 13 may provided not spreading outward over the inner edge 22c.

FIG. 14C and FIG. 14D are schematic cross-sectional views illustrating the manufacturing process of the alignment film 12 according to the embodiment.

As shown in FIG. 14C, the first frame 21 is formed on the substrate 10. For example, the ink jet method is used to apply ink containing a material that reduces the contact angle of the ink that forms the first portion 13.

Next, as shown in FIG. 14D, the second frame 22 is formed along the outer edge 24b of the first frame 21 using the ink jet method. The applied ink that forms the second frame 22 contains a material that increases the contact angle of the ink that forms the first portion 13.

Next, the ink that forms the first portion 13 is applied to the region surrounded by the first frame 21 on the substrate 10. The inks that form the portions mentioned above are cured at a prescribed temperature after the application. Thus, the substrate unit 3 may be provided as shown in FIGS. 14A and 14B.

In the embodiment, the first frame 21 is disposed in the inside portion of the second portion 14 (the peripheral frame), and reduces the contact angle of the ink that forms the first portion 13. That is, the ink that forms the first portion 13 may spread over the first frame 21, and providing uniform thickness in a portion near the outer edge of the first portion 13.

On the other hand, an outer frame is provided in the outside portion of the second portion, and increases the contact angle of the ink that forms the first portion 13. Thereby, overflowing of the ink may be suppressed at the outside of the peripheral frame, and it may be possible to prevent the alignment film 12 from spreading outward.

### Fourth Embodiment

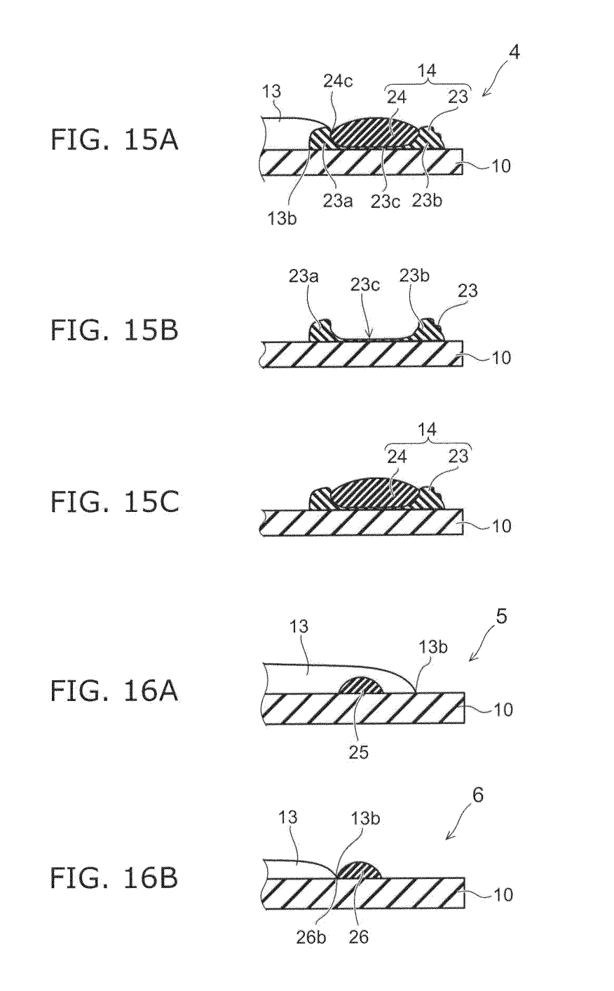

FIG. 15A to FIG. 15C are cross-sectional views illustrating a substrate unit 4 of a liquid crystal display device according to a fourth embodiment. Also the substrate unit 4 according to the embodiment includes the substrate 10 and the alignment film 12 provided on the substrate 10. The alignment film 12 includes the first portion 13 corresponding to the display portion and the second portion 14 surrounding the first portion 13.

As shown in FIG. 15A, the second portion 14 includes a third frame 23 and a fourth frame 24. The third frame 23 is provided along the outer edge 13b of the first portion 13. The third frame 23 contains a material that reduces the contact angle of the ink that forms the first portion 13. The contact angle of the ink on the third frame 23 is, for example, 5 degrees or less.

The third frame 23 has a protrusion 23a in contact with the outer edge 13b of the first portion 13 and a protrusion 23b formed along the outer edge of the protrusion 23a, and has a recess 23c between the protrusion 23a and the protrusion 23b.

The fourth frame 24 is provided on the recess 23c between the protrusion 23a and the protrusion 23b. The fourth frame 24 contains a material that increases the contact angle of the ink that forms the first portion 13. The contact angle of the ink on the fourth frame 24 is, for example, 40 degrees or more. The inner edge 24c of the fourth frame 24 is located near the top of the protrusion 23a, and is in contact with the third frame 23. The first portion 13 includes part in contact with the upper surface 10c of the substrate 10 and other part in contact with the third frame 23. Thus, It may be possible to prevent the first portion 13 from spreading outward beyond the inner edge 24c.

FIG. 15B and FIG. 15C are cross-sectional views illustrating the manufacturing process of the liquid crystal display device according to the fourth embodiment.

As shown in FIG. 15B, the third frame 23 is formed on the substrate 10. The third frame 23 is formed using, for example, the ink jet method, and contains a material that reduces the contact angle of the ink that forms the first portion 13. As described above, setting the temperature of the substrate 10 to, for example, 60° C. provides the protrusions 23a and 23b in the third frame.

Next, as shown in FIG. 15C, the fourth frame 24 is formed on the recess 23c between the protrusion 23a and the protrusion 23b using the ink jet method. The ink that forms the fourth frame 24 contains a material that increases the contact angle of the ink that forms the first portion 13.

Next, the first portion 13 is formed in the region surrounded by the third frame 23 and the fourth frame 24 on the substrate 10. Thus, the substrate unit 4 shown in FIG. 15A is manufactured.

FIG. 16A and FIG. 16B are cross-sectional views illustrating substrate units 5 and 6 according to comparative examples of the third and fourth embodiments.

As shown in FIG. 16A, a contact angle of the ink that forms the first portion 13 is small on a peripheral frame (a second portion 25) included in the substrate unit 5. Therefore, the ink applied to the region where the first portion 13 will be formed easily spreads outward beyond the peripheral frame. Consequently, it is difficult to control the outer edge 13b of the alignment film 12.

On the other hand, in the example of FIG. 16B, the contact angle of the ink that forms the first portion 13 is large on a peripheral frame (a second portion 26) included in the substrate unit 6. Therefore, the spreading of the ink that forms the first portion 13 is blocked at the position in contact with the inner edge 26b of the peripheral frame. Consequently, the thickness of the first portion 13 becomes thinner from the center side toward the outer edge 13b. That is, the uniformity of thickness is deteriorated at the outer edge of the first portion 13.

In contrast, in the substrate units 3 and 4 according to the embodiment, the first frame and the third frame provided in the inside portion of the peripheral frame facilitates the spreading of the ink that forms the first portion 13, and the second frame and the fourth frame block the spreading of the ink due to a large contact angle of the ink. Therefore, the spreading of the alignment film 12 may be suppressed while keeping the uniformity of the film thickness of the first portion 13. As a result, it becomes possible to realize the downsizing of the liquid crystal display device with lower cost.

Although the above embodiments are described referring to an example of the liquid crystal display device, the embodiment is not limited thereto. For example, the embodiment may be applied to any device that is manufactured through a process of forming film by spraying a liquid material.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A method for forming a film,
the film comprising:
a first portion provided on a substrate; and
a second portion provided along an outer edge of the first portion, and surrounding the first portion,
the method comprising:
forming the second portion by spraying liquid drops on the substrate, each of the liquid drops containing material of the second portion; and
forming the first portion by spraying other liquid drops on a region in the substrate, the region being surrounded by the second portion, and each of the other liquid drops containing material of the first portion.

2. The method according to claim 1, wherein a temperature of the substrate for forming the second portion is higher than a temperature of the substrate for forming the first portion.

3. The method according to claim 1, wherein the second portion is formed so as to include a plurality of dots.

4. The method according to claim 1, wherein each of the liquid drops and the other liquid drops includes organic solvent and polyimide dispersed therein.

5. The method according to claim 1, wherein the second portion is formed so that the first portion becomes a rectangular shape.

6. The method according to claim 1, wherein the material of the second portion is repeatedly applied on the second portion so that the second portion becomes thicker than the first portion.

7. The method according to claim 1, further comprising:
forming a transparent electrode on the substrate,
wherein a contact angle of the liquid drop containing the material of the first portion becomes smaller on the transparent electrode than a contact angle thereof on the substrate.

8. The method according to claim 1, wherein dots are formed in the first portion by spraying the other liquid drops on the substrate so that each of the dots has a diameter larger than the smallest distance between the spraying positions of the other liquid drops.

9. The method according to claim 1, wherein dots are formed along an outer edge of the second portion by spraying part of the liquid drops so that a center of the each dot keeps a fixed distance from an outer edge of the substrate.

10. The method according to claim 1, wherein dots are formed in the second portion by spraying the liquid drops on the substrate so that each of the dots has a diameter smaller than the smallest distance between the spraying positions of the liquid drops.

11. The method according to claim 1, wherein dots are formed in the second portion by spraying the liquid drops on a substrate so that each of the dots has a diameter almost equal to the smallest distance between the spraying positions of the liquid drops.

12. The method according to claim 1, wherein
a second portion including a first frame formed along an outer edge of the first portion and a second frame formed along an outer edge of the first frame, and
each of the other liquid drops has a larger contact angle on the second frame than a contact angle thereof on the first frame.

13. A liquid crystal display device comprising:
a substrate; and
an alignment film provided on the substrate,
the alignment film including:
a first portion provided in a region corresponding to a display portion; and
a second portion provided along an outer edge of the first portion and surrounding the first portion, the second portion being provided to be higher than the first portion.

14. The device according to claim 13, wherein the second portion includes a portion thicker than the first portion.

15. The device according to claim 13, wherein the second portion includes a plurality of dots.

16. The device according to claim 15, wherein the plurality of dots are provided apart from each other.

17. The device according to claim 15, wherein the plurality of dots are provided in contact with each other.

18. The device according to claim 13, wherein
the second portion includes a first protrusion provided along an outer edge of the first portion and a second protrusion provided along an outer edge of the first protrusion; and
the first protrusion and the second protrusion are higher than the first portion.

19. The device according to claim 13, wherein
the second portion includes a first frame provided along an outer edge of the first portion and a second frame provided along an outer edge of the first frame; and
a contact angle of ink applied to the first portion is smaller on the first frame than a contact angle of the ink on the second frame.

20. The device according to claim 13, wherein
the second portion includes:
a third frame including a first protrusion provided along an outer edge of the first portion and a second protrusion provided along an outer edge of the first protrusion; and
a fourth frame provided between the first protrusion and the second protrusion and
a contact angle of ink applied to the first portion is smaller on the third frame than a contact angle thereof on the fourth frame.
